(19) United States
(12) Patent Application Publication
(10) Pub. No.: US 2010/0017132 A1
(43) Pub. Date: Jan. 21, 2010

(54) METHOD FOR EVALUATING MEASURED ELECTROMAGNETIC DATA RELATING TO A SUBSURFACE REGION

(75) Inventors: MICHAEL EDWIN GLINSKY, Houston, TX (US); Anis Ahmad Inayat-Hussain, Kensington (AU); Guimin Liu, Bull Creek (AU); Terry Robb, Melbourne (AU); David Brian Boggs, Kensington (AU); James Stuart Gunning, Brunswick East (AU)

Correspondence Address: KOPPEL, PATRICK, HEYBL & DAWSON, 2815 Townsgate Road, SUITE 215, Westlake Village, CA, 91361-5827, US

(73) Assignee: BHP BILLITON INNOVATION PTY LTD

(21) Appl. No.: 12/176,063

(22) Filed: Jul. 18, 2008

(51) Int. Cl. G01V 3/12; G06F 19/00; G06Q 10/00

(52) U.S. Cl. 702/7; 702/6; 705/7

(57) ABSTRACT

A method for evaluating measured electromagnetic (EM) data relating to a subsurface region, comprising the steps of: (a) specifying at least one model of the region in terms of fundamental parameters with uncertainty, using a fundamental inversion grid; (b) receiving the measured EM data and an estimated error; (c) translating the fundamental parameters of the model to meta parameters of the region and to a computational grid suitable for forward modelling and comparison to the measured EM data, using relationships with uncertainty; and (d) carrying out a Bayesian inversion using the measured data and estimated error to produce an output comprising fundamental parameters of the region on the fundamental inversion grid with uncertainty. The method allows physical measurements with error to be translated into fundamental parameters which can be used to assess business risk and uncertainty for making decisions, and also provides for parameters and models which can typically be directly estimated by a geoscientist on a coarse spatial grid to be used as an input, and validated using the measured data with error.

The present invention relates to the evaluation of measured electromagnetic data relating to a subsurface region, and in particular to the translation of physical measurements with error into parameters which may be used in the assessment of business risk and uncertainty for making decisions.

### BACKGROUND OF THE INVENTION

in the acquisition and interpretation of data relating to subsurface regions, in particular for the appraisal of potential oil or gas reservoirs, the geoscientist will typically be able to provide an estimated model of the region in terms of certain physical parameters with specified estimated uncertainties. The parameters used by the geoscientist may include such properties as net-to-gross, water saturation, fluid type or porosity, and are usually only estimated in relation to a coarse spatial grid. However, these parameters typically differ from the properties of the region which are measured and collated in the form of survey data, which may include such properties as resistivity. These latter properties are also those which are typically used in mathematical inversions when analyzing measured data of the region, and are usually required to be specified on a much finer computational grid when carrying out mathematical inversions of the region.

The kinds of properties which are typically directly estimated by the geoscientist are therefore not directly applicable for use as input constraints in the mathematical modelling and inversion using the measured data, the inversion being based on intermediate variables such as resistivity of the region.

Furthermore, the measured data is also not typically of a type suitable for direct use by the business decision maker in making economic decisions regarding exploitation of the region, and the economic uncertainty information required by the business decision maker is likely to be more closely related to the parameters estimated by the geoscientist than to the measured physical data. For example, the business decision maker may require an estimate of the probability of a particular type or amount of hydrocarbon being present in a region, estimates of the thickness of a sub-surface layer, net-to-gross values, etc.

There is therefore a problem of how to move physical measurements that always have error into the risk and uncertainty needed by decision makers. Two examples of areas in which physical measurements require conversion before use as the basis of business decisions are the use of Controlled Source Electrical & Magnetic (CSEM) data, and the use of Acoustic Seismic Imaging Velocities (ASIM) data. Both of these data have measurement error that can be estimated.

There is also a need to map the properties directly estimated by the geoscientist, usually on a relatively coarse, layer-based grid, onto a grid of parameters suitable for physical modelling, often using a finer and more regular grid.

“Large scale 3D EM inversion using optimized simulation grids nonconformal to the model space”, Commer M. et al (SEG/New Orleans 2006 Annual Meeting) discloses a technique to reduce the required computational effort of large-scale electromagnetic (EM) modelling, and in particular inversion, for example using marine CSEM survey data. Where finely gridded earth models are used to capture realistic structures, the forward modelling operator may act on a coarser simulation grid, or a subsection of the model grid, in order to reduce the computational requirements of the inversion.

It is also desirable to provide a method for using measured physical data to validate estimated models of the region which use different parameters than the measured data, for example the kinds of parameters typically directly estimated by the geoscientist. In particular, it may be desirable to be able to use a set of physical measurements with error to determine probabilities for each of a set of alternative estimated models. In other words, it is useful for the geoscientist to be able to disregard possible models of the region, but the elimination of such models from consideration should be based on the measured data.

### SUMMARY OF THE INVENTION

A new and improved method is disclosed for evaluating measured electromagnetic (EM) data, for example controlled source electromagnetic (CSEM) data, relating to a subsurface region, the method comprising the steps of:
(a) specifying at least one model of the region in terms of fundamental parameters with uncertainty, using a fundamental inversion grid;
(b) receiving the measured EM data and an estimated error,
(c) translating the fundamental parameters of the model to meta parameters of the region and to a computational grid suitable for forward modelling and comparison to the measured EM data, using relationships with uncertainty; and
(d) carrying out a Bayesian inversion using the measured data and estimated error to produce an output comprising fundamental parameters of the region on the fundamental inversion grid with uncertainty.

The method allows physical measurements with error to be translated into fundamental parameters which can be used to assess business risk and uncertainty for making decisions, and also provides for parameters and models which can typically be directly estimated by a geoscientist on a coarse spatial grid to be used as an input constraint, and validated using the measured data with error.

In one arrangement, the computational grid is different from, e.g. finer than, the inversion grid, and step (c) further comprises mapping the meta parameters onto the computational grid or mapping the fundamental parameters onto the computational grid before translation to meta parameters.

In a further arrangement, the inversion produces probability distributions for the meta parameters, and the method further comprises the step of: (e) translating the output meta parameters into fundamental parameters using the same relationships as in step (c). In this case, the computational grid may be different from the inversion grid, and step (e) further comprises mapping the fundamental parameters onto the inversion grid.

Using the described method, prior constraints can be introduced by the geoscientist on the input model(s) in terms of fundamental parameters (e.g. layer thickness), rather than on meta parameters such as resistivity which are not typically able to be directly estimated in a meaningful way. This is in contrast with previous methods in which arbitrary constraints have been used in the inversion parameters to ensure convergence, but without relating directly to the geoscientist's estimates of properties of the region. In other words, the method, uses two different sets of properties: fundamental parameters which are business-relevant and also of significance to the geoscientist; and meta parameters which are those that are directly inverted.

### BRIEF DESCRIPTION OF THE DRAWING

Further embodiments, advantages, features and details of the method will be set out in the following description with reference to the drawing, in which:

FIG. 1 is a flow chart illustrating schematically the described method.

### DETAILED DESCRIPTION

The described method for evaluating EM data can be embodied in many different forms. The disclosure and description of the method are illustrative and explanatory thereof, and various changes in the parameters used and the details of the process steps may be made without departing from the scope of the invention.

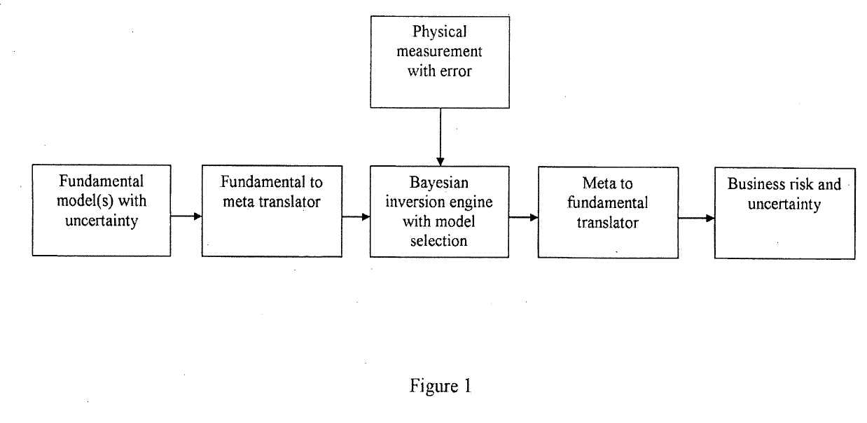

The main steps of the method are illustrated in FIG. 1. In an initial step, at least one model of a subsurface region is specified in terms of parameters which are referred to here as fundamental parameters with uncertainty. These are typically parameters that can directly be estimated by the geoscientist. In other words, this step allows the problem to be posed in such a way that the geoscientist can specify one or more alternative input models of the region in terms of parameters which he or she is able to estimate, but which are not directly measured properties of the region. Often, such parameters are also directly related to the economic value needed by the business decision maker. For instance, the model can be specified by the total thickness of the reservoir and non-reservoir layers of the earth, the ratio of reservoir rock to non-reservoir rock in the reservoir layers (net-to-gross ratio), and the type of fluid contained in the reservoir layer. These are parameters which may be broadly estimated with uncertainties by the geoscientist on the basis of known geological information, and are also parameters which are of direct interest to the business decision maker in making economic decisions and evaluating business risk. However, this is in contrast to the physical parameters of the region (referred to here as meta parameters) such as the resistivity and acoustic velocity, which form part of the measured data. Although these meta parameters are needed in order to carry out the physical modeling, they are not natural properties for the general geoscientist to specify, or for the businessman to evaluate.

In addition to the difference in the type of properties, the fundamental parameters used to specify the input model(s) usually only need to be known on a rather coarse and irregularly sampled layer-based grid. In contrast, the meta parameters often need to be sampled on a much more dense, and often regular grid for the physical forward modeling. The uncertainty of the meta parameters must also be estimated for use in the forward modeling.

Therefore, as shown in FIG. 1, the fundamental parameters of the input model(s) are then translated or mapped into physical or meta parameters with uncertainty. In order to achieve this, the fundamental parameters are translated to meta parameters with estimated uncertainty, and the meta parameters are also typically mapped or resampled onto a different grid suitable for use in the forward modeling (referred to here as the computational grid). This remapping can be done in many ways but a common implementation would be to utilize kriging to carry out the resampling. The property translation may be done by using property correlations (with uncertainty) and physical relationships. An example of the property correlation would be the resistivity as a function of depth for the reservoir and the non-reservoir rock (with uncertainty), and an example of a physical relationship would be the expression for resistivity of the reservoir layer in terms of the fluid in the rock, the resistivity of the reservoir rock with hydrocarbons, the resistivity of the non-reservoir rock, and the net-to-gross ratio.

In the next step, physical measurements with estimated error are received and used in the selection of a set of meta parameter models that are consistent with both the input meta model with uncertainty, and the physical measurement within the estimated error. The physical measurements may comprise, for example, CSEM survey resistivity data. If there are multiple fundamental models specified in the input step, then the relative probability of each model may be estimated on the basis of the physical measurements with error, and may also take into account a probability of each model estimated by the geoscientist during the input step. A common way to do this is with Bayesian inversion and model selection, as shown in FIG. 1. In this case, the probability of each model may be determined using a Bayesian technique based on the marginal model likelihood of each: inversion. Similarly, the method may be used to indicate the range of a particular parameter within an input model type (e.g. a range of thicknesses for a particular layer of a model) which falls within the measurement data and error.

The inversion preferably involves a forward model that predicts the measurement given the estimated model physical parameters. Examples of forward models include 1D Hankel transformation for 1D CSEM, 3D finite difference and element codes for CSEM, Kirchoff migration for ASIM, and wave equation migration for ASIM. One possible implementation of the inversion incorporates the multiple models into a mixed integer Bayesian inversion. The Bayesian inversion may include a conjugate gradient optimization, and may also include a Monte Carlo Metropolis Chain (MCMC) method for sampling the uncertainty.

The results of this process are then translated back into fundamental parameters and may be sampled (with uncertainty) back onto the original fundamental grid, as shown in FIG. 1. This may be done by using the same relationships used to carry out the forward translation in the fundamental to meta translation step. However, one possible implementation of this method imbeds the some or all of the translations into the inversion's forward model and inverts to the fundamental, not the meta parameters.

Once the results of the inversion have been translated back into fundamental parameters, the method provides information which can be used by the business decision maker to determine financial risk and uncertainty, this information being based on the geoscientist's estimated model(s) and uncertainty, validated by the physical measurement with error. For example, input constraints may be specified on the basis of general knowledge of the surrounding region in terms of a probability of the presence of oil, estimated layer thicknesses and uncertainties, etc, without a requirement to specify constraints in teems of physical parameters such as resistivity. The output of the method may then provide an updated estimate of the probabilities, layer thicknesses and uncertainties, on the basis of the measurement data and the estimated prior constraints.

The output probabilities may then be used to provide a direct estimate of the economic viability of exploring the region, which can be used in business decisions. If required, further forward processing may be carried out to determine expected values or other viability information. For example, layer thicknesses may be integrated to estimate total fluid volume, etc.

The above description sets out a particular embodiment of the method. However, modifications may be made within the scope of the claims. In particular, the order of certain steps in the claims may be altered where it is clear to the skilled person that the same effect can be achieved, and certain steps may be merged and carried out at the same time.

1. A method for evaluating measured electromagnetic (EM) data relating to a subsurface region, comprising the steps of:
(a) specifying at least one model of the region in terms of fundamental parameters with uncertainty, using a fundamental inversion grid;
(b) receiving the measured EM data and an estimated error;
(c) translating the fundamental parameters of the model to meta parameters of the region and to a computational grid suitable for forward modelling and comparison to the measured EM data, using relationships with uncertainty; and
(d) carrying out a Bayesian inversion using the measured data and estimated error to produce an output comprising fundamental parameters of the region on the fundamental inversion grid with uncertainty.

2. The method of claim 1, wherein the computational grid is different from the inversion grid, and step (c) further comprises mapping the meta parameters onto the computational grid or mapping the fundamental parameters onto the computational grid before translation to meta parameters.

3. The method of claim 2, wherein the computational grid is finer than the inversion grid.

4. The method of claim 2, wherein the meta or fundamental parameters are mapped onto the computational grid using a kriging technique.

5. The method of claim 1, wherein the inversion produces probability distributions for the meta parameters, and the method further comprises the step of:
(e) translating the output meta parameters into fundamental parameters using the same relationships as in step (c).

6. The method of claim 5, wherein the computational grid is different from the inversion grid, and step (e) further comprises mapping the fundamental parameters onto the inversion grid.

7. The method of claim 1, wherein the EM data comprises controlled source electromagnetic (CSEM) data.

8. The method of claim 1, wherein the fundamental parameters include one or more of: net-to-gross, water saturation, porosity, and fluid type.

9. The method of claim 1, wherein the meta parameters include resistivity.

10. The method of claim 1, further comprising the step of additional forward computation of the output fundamental parameters to produce business risk and/or uncertainty information.

11. The method of claim 1, wherein the output includes, for at least one fundamental parameter within the specified model, a range of values determined to be consistent with the measured data and estimated error.

12. The method of claim 1, wherein the Bayesian inversion of step (d) includes a conjugate gradient optimization.

13. The method of claim 1, wherein the Bayesian inversion of step (d) includes a Monte Carlo Metropolis Chain (MCMC) method for sampling the uncertainty.
